(19) United States
(12) Patent Application Publication
(10) Pub. No.: US 2024/0388032 A1
(43) Pub. Date: Nov. 21, 2024

(54) ELECTRONIC PORT UTILITY ADAPTER

(71) Applicant: Richard M. Beechler, Lodi, CA (US)

(72) Inventor: Richard M. Beechler, Lodi, CA (US)

(21) Appl. No.: 18/197,923

(22) Filed: May 16, 2023

(51) Int. Cl. H01R 13/443; B60R 11/00

(52) U.S. Cl. CPC H01R 13/443; B60R 11/00; B60R 2011/0003; B60R 2011/0061

(57) ABSTRACT

Systems, devices, and methods for mounting various devices to electronic device ports.

### BACKGROUND OF THE INVENTION

### 1. Field of the Invention

The present invention pertains to systems, devices, and methods for mounting various devices to electronic device ports.

### 2. Background of the Invention

Mounting devices for accessories come in many forms. Typical solutions involve utilizing a surface in a given environment and providing a mounting bracket and fasteners to mount onto a surface, or clamps to clamp a portion of a surface, or suction cups to create a vacuum to seal the suction cup to a surface, or magnets, or adhesives. However, many surfaces are too hard or brittle for fasteners, too soft or irregular shaped for clamping, too rough for suctioning, non-magnetic, or in environments not suited for adhesives. Furthermore, using fasteners, clamps, suction cups, magnets, and/or adhesives may damage the surface being used for mounting.

What is needed in the art is a solution that provides a simpler way to mount accessories.

### SUMMARY OF THE INVENTION

Personal accessories—such as, thermometer, hula girl dash ornament, compass, car camera, and dash light.

Vehicle accessories—such as, air fresheners, phone accessories, sun visors, ashtrays, organizers, air purifiers, lights, fans, key fob holders, trash bag holders, ornaments, toys, sports memorabilia, weather detectors or monitors, or microphones—typically require a mounting portion to affix the accessory to the vehicle. However, many vehicles do not provide mounting portions for the accessories.

Electronic devices, e.g. mobile devices, wearables, televisions, monitors, laptops, tablets, computers, appliances, computers, printers, scanners, speakers, cameras, dvd players, and hard drives, have become indispensable from people's life and work environment. Connectivity between devices is typically achieved through the use of various ports—such as headphone jacks, Universal Serial Bus (“USB”) ports, USB-A, USB-B, USB-C, USB 3.0, High-Definition Multimedia Interface (“HDMI”), Mini HDMI, Micro HDMI, Ethernet, DisplayPort, PS/2, Serial Port—DB-25, DE-9, RS-232 or COM Port, Parallel Port, Centronics 36 Pin Port, Audio Ports—Surround Sound Connectors or 3.5 mm TRS Connector, S/PDIF/TOSLINK, Video Ports, RF/COAX, VGA Port, Digital Video Interface (“DVI”), Mini-DVI, Micro-DVI, Display Port Mini, Display Port, RCA Connector, Component Video, S-Video, RJ-45, RJ-11, or e-SATA.

Many electronic devices are portable, hence the reason why the aforementioned ports are also being provided in transportation vehicles. In many instance, multiple types of ports are being provided thus giving the end user with typically more ports than end-user devices. In other cases, all ports are being used; however, an end-user still desires an easy mounting solution. The present invention provides an alternative solution for mounting of personal accessories—regardless of location. While several types of accessories have been described, there is not intent to limit the type of accessory to those disclosed and it should be understood that the present invention is adaptable to support many types of vehicle accessories.

In one exemplary embodiment formed in accordance with the present disclosure, there is provided a vehicle accessory adaptor. The adaptor includes a first member having a first surface and a second surface being substantially parallel to the first surface. The adaptor also includes a second member in connection with the first surface and being configured for supporting a vehicle accessory and a third member in connection with the second surface and being configured for connection with a vehicle port. The second member may be removably attachable to the first member while the third member is configured for connecting with a USB-C vehicle port.

In one exemplary embodiment there is a method for mounting an accessory. The method generally includes the steps of providing an electronic port, providing a port adaptor, inserting the port adaptor into the electronic port, and mounting an accessory to the port adaptor.

An advantage of the present invention is to provide a mounting point for accessories.

Another advantage of the present invention allows interchangeability of the main body with the same mounting and connection points.

Another advantage of the present invention is to provide a mounting point for accessories while allowing concurrent use of the respective port.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1A illustrates an embodiment of a port adaptor according to the invention;

FIG. 1B illustrates an opposite side view of the embodiment shown in FIG. 1A;

FIG. 2A illustrates yet another embodiment of a port adaptor according to the invention;

FIG. 2B illustrates an opposite side view of the embodiment shown in FIG. 2A;

FIG. 3 illustrates yet another embodiment of a port adaptor according to the invention;

FIG. 4 illustrates yet another embodiment of a port adaptor according to the invention; and

FIG. 5 illustrates a method of using an embodiment of a port adaptor according to the invention;

### DETAILED DESCRIPTION OF THE INVENTION

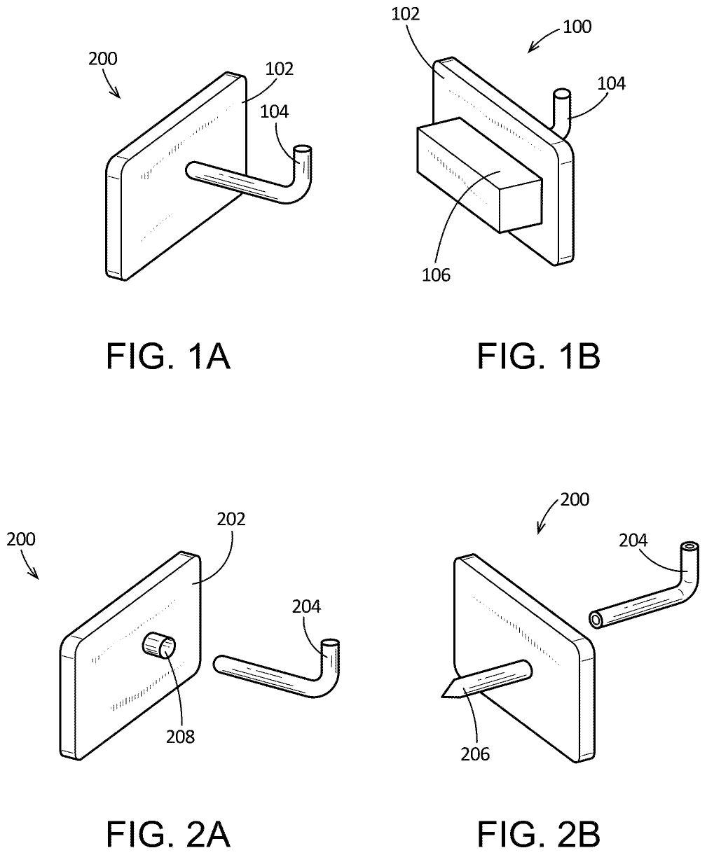

Referring now to the drawings, are more particularly to FIGS. 1A and 1B there is shown an exemplary embodiment of a Port Adaptor 100.

The Port Adaptor 100 generally includes a main body 102, a utility portion 104, and a connecting portion 106. The port adaptor 100 utility portion 104 is generally shown in FIG. 1A while the port adaptor 100 connecting portion 106 is generally shown in FIG. 1B.

The port adaptor 100 main body 102 may be of any shape or size or thickness, for instance, a rectangular shape having a width of 0.5″, a height of 0.25″, and a thickness of 0.15″ or a circle having a diameter of 0.5″ or other shapes—for instance but not limited to: stars, feet, animals, insects, architecture, buildings, abstract, or any other shape imaginable. It should be noted that while specific dimensions have been provide, the dimensions are being provided merely for illustrative purposes and should not be considered to limit the main body 102 dimensions and/or shape.

The port adaptor 100 utility portion 104 may be formed as one piece with the main body 102 or the utility portion 104 may be removably detachable. If removably detachable, the utility portion 104 may be attached to the main body 102 via a friction fit between the main body 102 and the utility portion 104, for instance through use of a post and a corresponding opening. The removably detachable connection may also be accomplished through use of a magnetic connection between the main body 102 and the utility portion 104, for instance, through utilization of magnets in the main body 102 and the utility portion 104 or through utilization of a magnet in either the main body 102 and the utility portion 104 with the corresponding component being made of a material that exhibits ferromagnetic properties. The utility portion 104 may also be removably attached via a locking mechanism.

The utility portion 104 may also be attached to the connecting portion 106. In this configuration, the utility portion 104 may include a shoulder at a transition point between the pass through utility portion 104 and the connecting portion 106. The shoulder advantageously provides a clamping portion to secure a main body 102 in place and allow for interchangeability of the main body 102 from one shape to another, for instance a beach ball shape to someone's initials. To illustrate—by way of example only—a user would insert a utility portion 104 having a connecting portion 106 and shoulder through an opening on the main body 102. The user would then take the combined units and insert the connecting portion 106 into an electrical port, pressing the connecting portion 106 into the port until the shoulder seats the main body 102 against a surface adjacent to the port or to the port itself.

The utility portion 104 may be configured for various types of vehicle accessories—for instance and not to limit the configurations—hooks for trash bags or key fobs, cable holders for charging cables or CB radio microphone, cable wraps, ornaments, toys, sports memorabilia, weather detectors or monitors, or any branding marks. The utility portion 104 may also be configured for more than one use, for instance, hooks and cable wraps, multiple hooks, etc.

The connecting portion 106 may be configured to connect with various ports, for instance, HDMI, RCA, USB-A, USB-B, USB-C, USB 3.0, 3.5 mm Audio, Ethernet, SD Card Reader, Micro SD Reader, DisplayPort, and Optical. While the aforementioned describe different types of data ports it should be understood that the connecting portion 106 may be configured to connect with other types of ports or openings such as a 12V DC opening. It should also be understood that the various ports may be located on any type of electrical device, regardless if mobile or permanently affixed.

The port adaptor 100 connecting portion 106 may be configured to insert into a port thus providing a connection to support anything that is being supported by the utility portion 104. In this type of configuration, use of the port for its intended purpose is blocked. For instance, a connecting portion 106 configured for inserting into a USB-B port may render the USB-B inoperable for the transfer of data and/or power.

However, the connecting portion 106 may alternatively be configured to provide a connection to support anything that is being supported by the utility portion 104 while allowing use of the port for its intended purpose. In this type of configuration, a connecting portion 106 configured for inserting into a USB-B port will allow the transfer of data and/or power from USB-B to a further connected device.

In another configuration, the port adaptor 100 includes a main body 102 and a utility portion 104. This configuration provides an opening through the main body 102 whereby a user supplied connection—for instance, a USB cable, is inserted through the opening on the main body 102 and then into the corresponding port. Once the USB cable is fully inserted, the cable clamps the main body 102 against a surface adjacent to the port or to the port itself.

Now referring to FIGS. 2A and 2B, there is shown a port adaptor 200. The port adaptor 200 generally includes a main body 202, a utility portion 204, a connecting portion 206, and a plurality of mounting portions 208. The port adaptor 200 utility portion 204 is generally shown in FIG. 2A while the port adaptor 200 connecting portion 206 is generally shown in FIG. 2B. In this configuration, the utility portion 204 is removably detachable from the main body 202 through use of one or more mounting portion 208. The mounting portion 208 shown in FIGS. 2A and 2B demonstrate a mounting configuration using friction to mount the utility portion 204 to the main body 202. This configuration advantageously provides the ability to alter the utility portion 204 for various uses, for instance, a hanger to place a bag for trash on or another instance to provide a cable wrap. However, the mounting portion 208 may include any type of configuration that allows for the removal and installation of a utility portion 204.

In another exemplary embodiment, a port adaptor 200 generally includes a main body 202 with an opening, utility portion 204, and a mounting portion 208. The mounting portion 208 is arranged on the main body 202 such that the opening through the main body 202 allows for placement of a user supplied connection—for instance, a 3.5 mm plug, is inserted through the opening on the main body 102 and then into the corresponding port. Once the 3.5 mm plug is fully inserted, the user supplied connection clamps the main body 202 against a surface adjacent to the port or to the port itself.

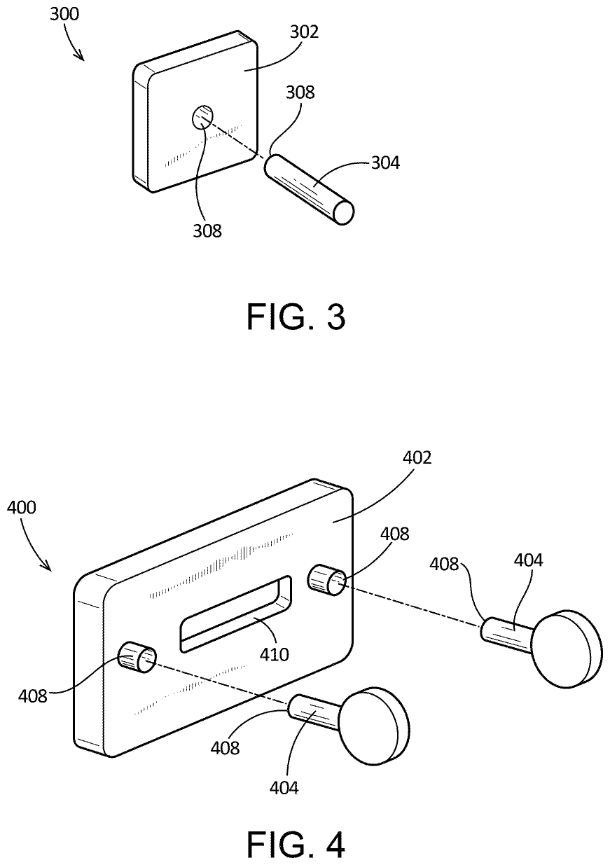

Now referring to FIG. 3, there is shown a port adaptor 300. The port adaptor 300 generally includes a main body 302 shown in a square shape; however, it should be understood that the shape may be any shape, such as, round, rectangular, triangular, or free body form. The utility portion 304 and the mounting portions 308 are being shown using a magnetic configuration to allow easy removal of the utility portion 304 for various uses, for instance, a hanger to place a bag for trash on or another instance to provide a cable wrap.

Now referring to FIG. 4, there is shown an exemplary embodiment of a port adaptor 400. The port adaptor 400 generally includes a main body 402, a plurality of utility portions 404, a plurality of mounting portions 408, and an active port 410. The active port 410 in this configuration provides use of the corresponding vehicle port while providing a mounting configurations for vehicle accessories. The active port may an extension of the respective port—for instance, the main body 402 may include a USB connection whereby one end is an active end that is inserted into the supplied port and the opposite end is utilized for a user supplied connection—for instance, a USB cable.

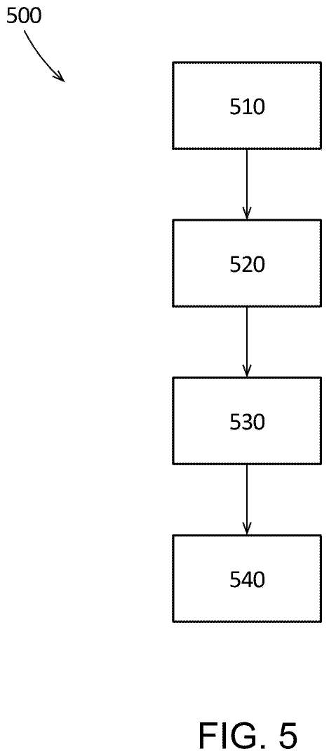

Now referring to FIG. 5, there is shown a method for using a port adaptor 500. The method generally includes the steps of providing a vehicle port 510, providing a port adaptor 520, inserting the port adaptor into the vehicle port 530, and mounting a vehicle accessory to the port adaptor 540. In another embodiment, the port adaptor may be supplied with a removable utility portion and/or connecting portion thereby allowing for alternate configurations of main bodies with the same utility portion and/or connecting portion. It may also provide the ability to use alternate utility portion and/or connecting portion with the same main body.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An accessory adaptor, the adaptor comprising:
a first member having a first surface and a second surface being substantially parallel to the first surface;
at least one second member being configured for supporting a vehicle accessory and in connection with the first surface; and
a third member being configured for connection with a vehicle port and in connection with the second surface.

2. The adaptor of claim 1, wherein the second member is removably attachable to the first member.

3. The adaptor of claim 1, wherein the third member is configured for inserting into a USB-C vehicle port.

4. The adaptor of claim 1, wherein the first member includes a plurality of second members.

5. The adaptor of claim 1, wherein the at least one second member is configured as a hook.

6. The adaptor of claim 3, wherein the third member is configured for providing a data from the vehicle port through the first member.

7. A mounting system for mounting accessories, the mounting system comprising:
an electronic port; and
an accessory adaptor, the adaptor including:
a first member having a first surface and a second surface being substantially parallel to the first surface;
at least one second member being configured for supporting a vehicle accessory and in connection with the first surface; and
a third member being configured for connection with a vehicle port and in connection with the second surface.

8. The mounting system of claim 7, wherein the electronic port is configured for a USB-C connection.

9. The mounting system of claim 8, wherein the electronic port is located on a radio.

10. The mounting system of claim 9, wherein the radio is located in a vehicle.

11. A method for mounting an accessory, the method comprising:
providing an electronic port;
providing a port adaptor;
inserting the port adaptor into the electronic port; and
mounting an accessory to the port adaptor.

12. The method of claim 11, wherein the electronic port is located in a vehicle.

13. The method of claim 12, wherein the port adaptor includes a plurality of second members being configured for mounting a plurality of vehicle accessories.

14. The method of claim 11, wherein the method further includes inserting a user supplied connection into the port adaptor.

15. The method of claim 13, wherein the plurality of second members are removably attachable to the port adaptor.
